(19) United States
(12) Patent Application Publication
(10) Pub. No.: US 2008/0242227 A1
(43) Pub. Date: Oct. 2, 2008

(54) Movable apparatus and duplex module thereof

(75) Inventor: Mei-Lan Cheng, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/007,934

(22) Filed: Jan. 17, 2008

(30) Foreign Application Priority Data
Mar. 30, 2007 (TW) 96111215

(51) Int. Cl. H04B 7/00

(52) U.S. Cl. 455/41.2

(57) ABSTRACT

A movable apparatus and a duplex module thereof are provided. A duplex module comprises a bluetooth wireless module and a wireless network module. The bluetooth wireless module is matched with and activates an electronic product. The wireless network module retrieves an internet protocol address by internet connection, wherein the electronic product uploads/downloads digital data through the wireless network module. A movable apparatus has a duplex module comprising a bluetooth wireless module and a wireless network module. The bluetooth wireless module is matched with and activates an electronic product. The wireless network module retrieves an internet protocol address by internet connection, wherein the electronic product uploads/downloads digital data through the wireless network module.

### BACKGROUND OF THE INVENTION

1. Field of the Invention

The invention relates to a movable apparatus and a duplex module thereof, and more particularly to a duplex module, applied in a movable apparatus, with combined bluetooth wireless technology and wireless internet technology.

2. Description of the Related Art

Recently, with the rapid development of wireless technology, applications of wireless products have been continuously expanded. It becomes more convenient for people to communicate. Wireless local area network (WLAN) and wireless bluetooth (BT) technology are typical examples. A user can experience convenience of wireless transmission by using a product (e.g. a portable computer, a cellular phone) having a wireless local area network (WLAN) card which allows the user to use the internet at any place where access point (APs) are provided. Wireless bluetooth technology is wireless communications technology capable of simultaneous voice and data transmission and provides high-frequency transmission insusceptible to interference, and high speed and volume transmission of image, voice, and data at a short distance. Furthermore, wireless bluetooth devices are generally lightweight and power-saving, and thus are always one of the preferred choices for data transmission.

Please refer to FIG. 1, which depicts a private vehicle managing various application devices. As shown in FIG. 1, different devices provide different functions (e.g. communications, satellite navigation, networks, etc.). Thus, car driver or passengers need to carry all the devices in their private vehicles 1 for using all the functions. Specifically, a cellular phone p is used for communications, a personal digital assistant (PDA) a associated with a global positioning system (GPS) s is used for satellite navigation, and a portable computer c is used for internet connection. Conventionally, accessing data between devices requires special transmission lines and it is not convenient. Furthermore, passengers are not able to deal with important matters in the vehicles due to due to equipment restrictions, thus, much time is wasted.

Thus, a duplex module, which integrates a wireless local area network module and a bluetooth module, helps passengers avoid carrying many different devices and allows passengers to fully use their travel time is desired.

### BRIEF SUMMARY OF THE INVENTION

To avoid the previously described problems, the invention provides a duplex module, applied in a movable apparatus, for integrating internet multitasking operations and operating a bluetooth wireless module in a confidential manner. The invention not only allows the user to avoid carrying a lot of different devices, but also fully utilizes a function of wireless transmission technology.

To achieve above, it is provided that the movable apparatus and the duplex module thereof comprise a bluetooth wireless module and a wireless network module. The bluetooth wireless module is matched with and activates an electronic product. The wireless network module accesses an internet protocol address by internet connection. The electronic product uploads/downloads digital data through the wireless network module.

The duplex module may communicate with a server, and the electronic product may be an electronic key. The wireless network module transmits an electronic signal to the server when the electronic key is not successfully matched with the bluetooth wireless module. Then, the server notifies at least one user via internet that the electronic key is not successfully matched with the bluetooth wireless module. Furthermore, the duplex module may be used with a video apparatus, wherein the images, picked up by the video apparatus, are transmitted immediately to the internet by the wireless network module.

The duplex module may be applied in a movable apparatus and connected to a global navigation satellite apparatus. The global navigation satellite apparatus provides a traffic situation indicating function and tracks a location of the duplex module. The electronic product is a mobile apparatus, for instance, a cellular phone, a hand-held computer, or a personal digital assistant (PDA), and internet technology is applied thereto.

In the foregoing movable apparatus, the duplex module may further report a special situation to a base transceiver station. The base transceiver station can calculate travel time needed by the movable apparatus and report a situation of the movable apparatus. The movable apparatus may be a vehicle, for instance, a saloon car or a special vehicle. The special vehicle may be a public transportation vehicle or an auxiliary rescue vehicle.

### BRIEF DESCRIPTION OF THE DRAWINGS

The invention can be more fully understood by reading the subsequent detailed description and examples with references made to the accompanying drawings, wherein:

FIG. 1 depicts a private vehicle managing various application devices.

FIG. 2A is a block diagram of a duplex module in accordance with an embodiment of the invention.

FIG. 2B is a block diagram of a movable apparatus with a duplex module of FIG. 2A.

FIG. 3A depicts the movable apparatus of FIG. 2B applied in burglarproof operations.

FIG. 3B depicts the movable apparatus of FIG. 2B applied in security monitoring operations.

FIG. 3C depicts the movable apparatus of FIG. 2B applied in navigation operations.

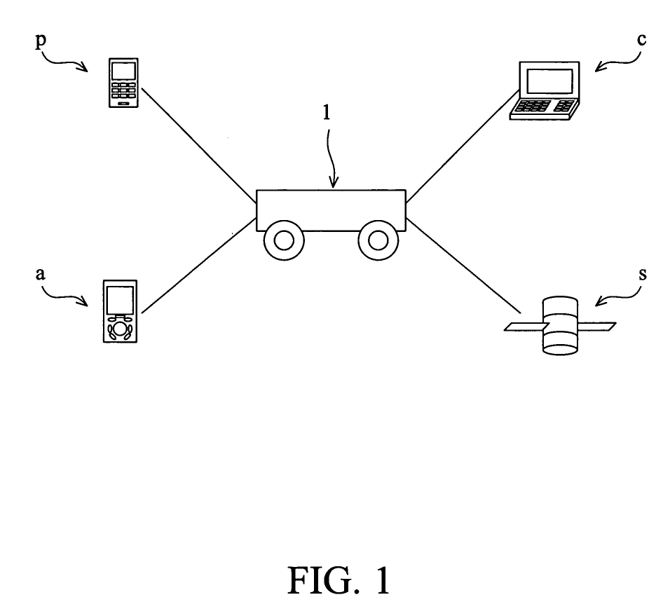

### DETAILED DESCRIPTION OF THE INVENTION

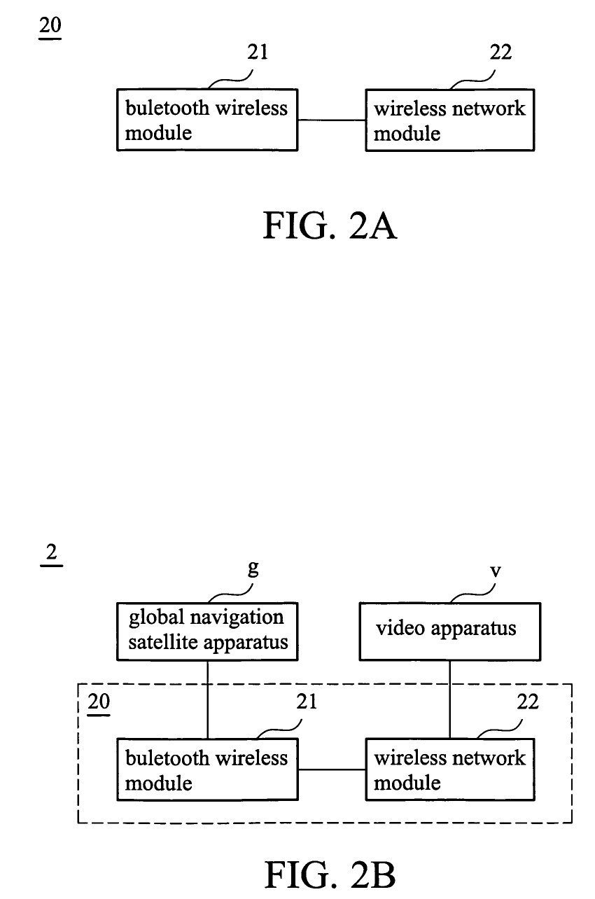

Please refer to FIG. 2A and FIG. 2B, wherein FIG. 2A is a block diagram of a duplex module in accordance with an embodiment of the invention and FIG. 2B is a block diagram of a movable apparatus with a duplex module of FIG. 2A. A movable apparatus 2, such as a saloon car, comprises a duplex module 20 comprising a bluetooth wireless module 21 and a wireless network 22. The bluetooth wireless module 21 is matched with and activates an electronic product. The wireless network module 22 gets an internet protocol address (IP address) by internet connection so that the electronic product can upload/download digital data through the wireless network module 22.

A global navigation satellite apparatus g may be connected to the duplex module 20 for providing a traffic situation indicating function and tracking a location of the duplex module 20. Furthermore, a video apparatus v may be connected to the duplex module 20, wherein the images, captured by the video apparatus v, are transmitted immediately to the internet by the wireless network module 22, as shown in FIG. 2B.

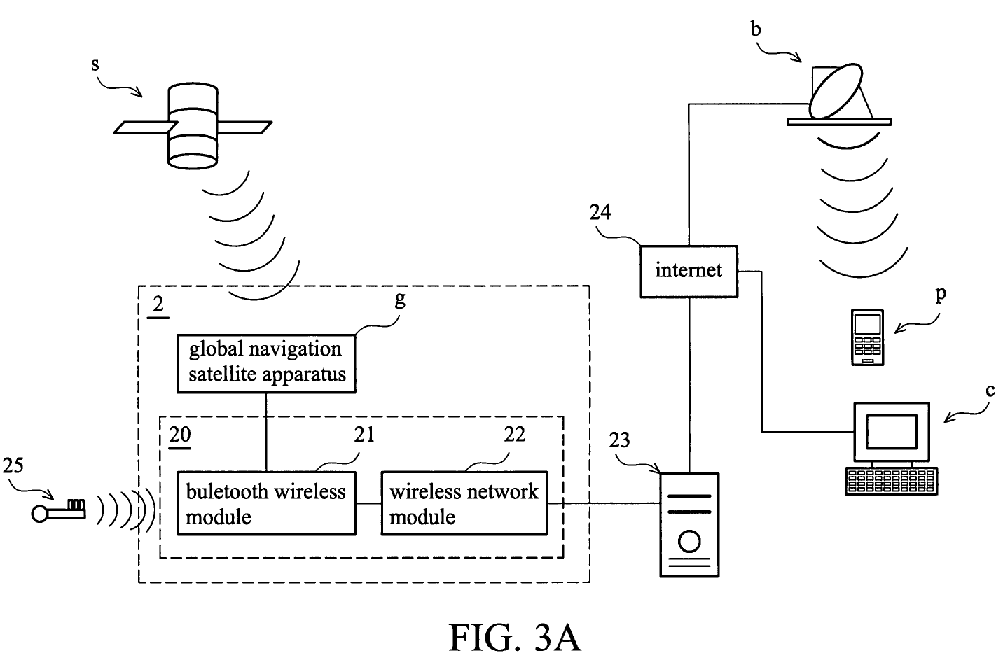

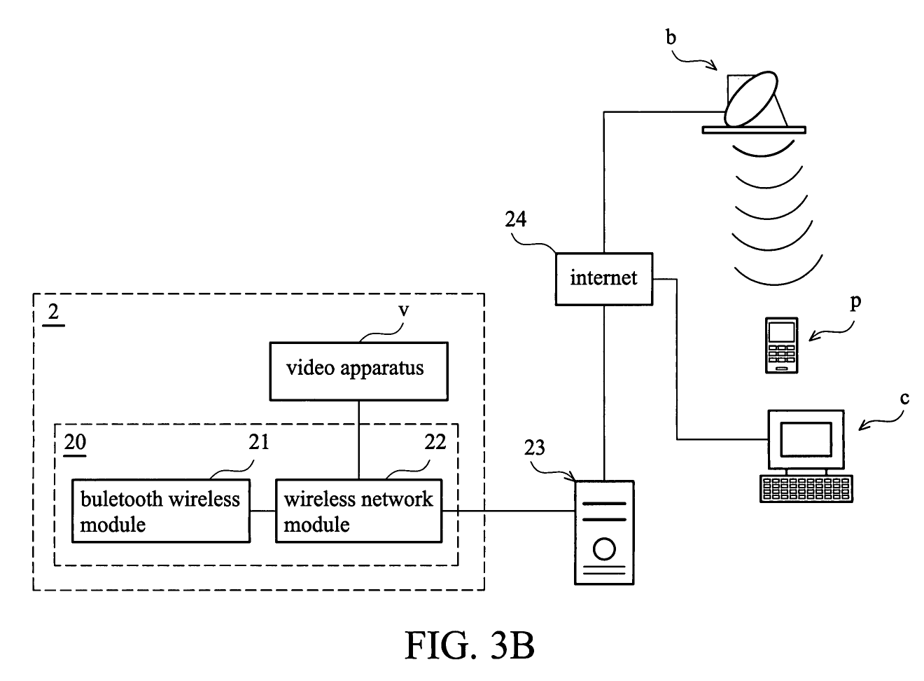

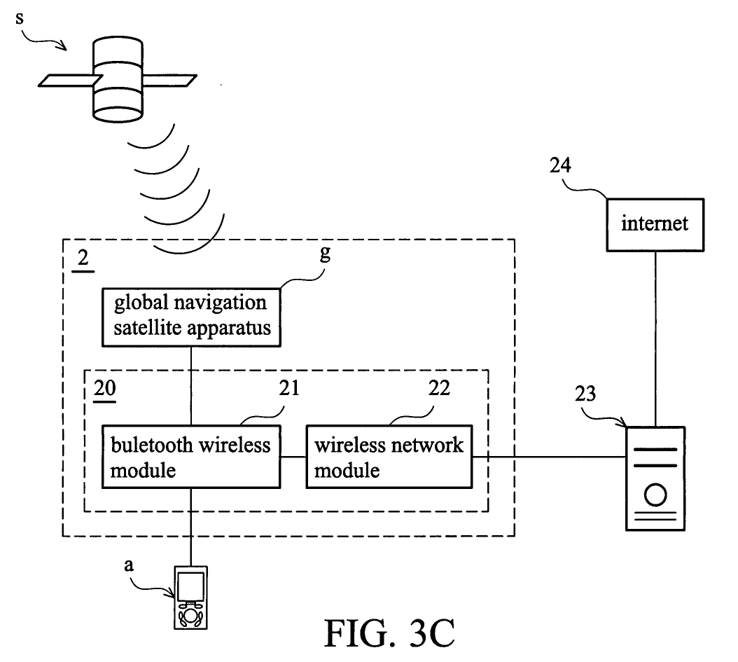

Please refer to FIG. 3A, which depicts the movable apparatus of FIG. 2B applied in burglarproof operations. As shown in FIG. 3A, the duplex module 20 comprises the bluetooth wireless module 21. Thus, the external electronic key 25 made by using bluetooth wireless technology is required to be matched with the bluetooth wireless module 21 when the user wants to activate the movable apparatus 2 with the duplex module 20. After the external electronic key 25 is successfully matched with the bluetooth wireless module 21, the movable apparatus 2 is able to be activated. However, when a lawless person repeatedly tries to crack the matching codes, the duplex module 20 sends an electrical single to a sever 23 via the wireless network module 22, The sever 23 immediately notifies at least one portable computer c of the user through the internet 24 or a base transceiver station b sends a massage to a cellular phone p of the user through the internet 24. That is, the duplex module 20 will warn the user to take prompt action if the electronic key 25 repeatedly fails to match with the bluetooth wireless module 21. If a thief successfully steals the movable apparatus 2, then the bluetooth wireless module 21 of the duplex module 20 will trigger the global navigation satellite apparatus g installed in the vehicle to transmit a signal to the global positioning systems. Thus, the user can track the location of the movable apparatus 2 and find it via the duplex module 20.

Please refer to FIG. 3B, which depicts the movable apparatus of FIG. 2B applied in security monitoring operations. As shown in FIG. 3B, when a video apparatus v is provided in the movable apparatus 2, the images, captured by the video apparatus 2, are transmitted immediately to the internet 24 by the wireless network module 22 of the duplex module 20. The user can utilize a mobile apparatus (e.g. a portable computer c, a cellular phone p, and other apparatuses allowing the user to use internet 24) to download the images of the movable apparatus 2 and observe what happens in the movable apparatus 2 (e.g. children are accidentally left in the vehicle).

When the duplex module 20 cooperates with the global navigation satellite apparatus g, the applications of the duplex module 20 can be expanded. Please refer to FIG. 3C, which depicts the movable apparatus of FIG. 2B applied in satellite navigation operations. When the movable apparatus 2 receives data relating to present location via global positioning systems (GPS)s, the data will be transmitted to the apparatus with map identification software by the bluetooth wireless module 21 of the duplex module 20 (e.g. a personal digital assistant (PDA) a for providing traffic situation information). Moreover, the user can connect the wireless network module 22 of the duplex module 20 to internet 24 to retrieve information concerning scenic spots such as traffic, weather, and other information.

When the movable apparatus 2 receives data relating to its present location from global positioning system (GPS)s, the user can get information relating to travel speed, safe distance with other vehicles by connecting the internet protocol address retrieved by the wireless network module 22 to the base transceiver station b. With respect to video applications, the duplex module 20 comprising the wireless network module 22 and the bluetooth wireless module 21 allows the user to make a net phone call by using the internet 24 and the bluetooth wireless technology, which is convenient and cost saving. If the users want to share digital films or photos with distant relatives and friends, they can directly transmit the data to the duplex module 20 by the bluetooth transmission technology and upload/download by the internet 24 to save storage space and fully utilize the internet 24, as shown in FIG. 3C.

The described duplex module 20 can be applied not only in a saloon car, but also in a special vehicle (e.g. a public transportation vehicle or an auxiliary vehicle). When the described duplex module is applied in a public transportation vehicle, it can transmit immediately the location of the vehicle and arrival time to a station or a shelter by using the wireless internet module 22. Thus, the passengers waiting for the vehicle will know the waiting time in advance so that they may be able to fully utilize the time to make necessary or desired arrangements. Also, the passengers on the vehicle can transmit and receive electronic mail, browse websites and listen to music transmitted by the wireless bluetooth module 21. When the duplex module 20 is applied in an auxiliary rescue vehicle, it allows the driver to find out the traffic situation through the internet 24 and avoid traffic jams so as to rapidly arrive at disaster areas. The condition of the injury can be reported to a hospital through the internet 24 for the medical care personnel to make preparations in advance for care treatment.

As described, advantages of the duplex module 20 include burglarproof, security monitoring, satellite navigation, travel monitoring, and communications. The duplex module integrates several products and avoids conventional inefficiencies (e.g. the user needs to carry several products simultaneously). The duplex module 20 can be further applied in public transportation vehicles and auxiliary rescue vehicles to save time, raise rescue efficiency and to fully serve functioned purposes.

While the invention has been described by way of example and in terms of preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A duplex module comprising:
a bluetooth wireless module matched with and activating an electronic product; and
a wireless network module retrieving an internet protocol address by internet connection;
wherein the electronic product uploads and/or downloads digital data through the wireless network module.

2. The duplex module as claimed in claim 1, wherein the duplex module communicates with a server.

3. The duplex module as claimed in claim 2, wherein the bluetooth wireless module is matched with an external electric key, and the wireless network module transmits an electronic signal to the server when the electronic key is not successfully matched with the bluetooth wireless module.

4. The duplex module as claimed in claim 3, wherein the server notifies at least one user via internet when the electronic key is not successfully matched with the bluetooth wireless module.

5. The duplex module as claimed in claim 1, wherein the duplex module is used with a video apparatus.

6. The duplex module as claimed in claim 5, wherein an image captured by the video apparatus is transmitted immediately to the internet by the wireless network module.

7. The duplex module as claimed in claim 1, wherein the duplex module is applied in a movable apparatus and connected to a global navigation satellite apparatus.

8. The dual function module as claimed in claim 7, wherein the global navigation satellite apparatus provides a traffic indicating function or tracks a location of the movable apparatus.

9. The dual function module as claimed in claim 1, wherein the electronic product is a portable apparatus, a cellular phone, a portable computer or a personal digital assistant.

10. A movable apparatus having a duplex module comprising:
a bluetooth wireless module matched with and activating an electronic product; and
a wireless network module retrieving an internet protocol address by internet connection;
wherein the electronic product uploads and downloads digital data through the wireless network module.

11. The movable apparatus as claimed in claim 10, wherein the duplex module communicates with a server.

12. The movable apparatus as claimed in claim 10, wherein the bluetooth wireless module is matched with an external electric key, and the wireless network module transmits an electronic signal to the server when the electronic key is not successfully matched with the bluetooth wireless module.

13. The movable apparatus as claimed in claim 12, wherein the server notifies at least one user via internet when the electronic key is not successfully matched with the bluetooth wireless module.

14. The movable apparatus as claimed in claim 10, further comprising a video apparatus, wherein an images captured by the video apparatus is transmitted immediately to the internet by the wireless network module.

15. The movable apparatus as claimed in claim 10, further comprising a global navigation satellite apparatus, wherein the global navigation satellite apparatus provides a traffic indicating function or tracks a location of the movable apparatus.

16. The movable apparatus as claimed in claim 10, wherein the electronic product is a portable apparatus, an apparatus using internet technology, a cellular phone, a portable computer or a personal digital assistant.

17. The movable apparatus as claimed in claim 10, wherein the movable apparatus reports a special situation to a base transceiver station, and the base transceiver station has a function of calculating travel time needed by the movable apparatus or a function of reporting a situation of the movable apparatus.

18. The movable apparatus as claimed in claim 10, wherein the movable apparatus is a vehicle, a saloon car, a special vehicle, a public transportation vehicle, or an auxiliary rescue vehicle.
